(19) United States
(12) Patent Application Publication
(10) Pub. No.: US 2013/0124192 A1
(43) Pub. Date: May 16, 2013

(54) ALERT NOTIFICATIONS IN AN ONLINE MONITORING SYSTEM

(71) Applicants: RUSS LINDMARK, OVERLAND PARK, KS (US); GLENN FISHER, LEAWOOD, KS (US); JACOB MORRIS DUBIN, PLEASANT HILL, MO (US); TIMOTHY JOSEPH MESSER, OLATHE, KS (US); JOSHUA PAUL MAY, OVERLAND PARK, KS (US); JESTIN STOFFEL, KANSAS CITY, KS (US)

(72) Inventors: RUSS LINDMARK, OVERLAND PARK, KS (US); GLENN FISHER, LEAWOOD, KS (US); JACOB MORRIS DUBIN, PLEASANT HILL, MO (US); TIMOTHY JOSEPH MESSER, OLATHE, KS (US); JOSHUA PAUL MAY, OVERLAND PARK, KS (US); JESTIN STOFFEL, KANSAS CITY, KS (US)

(73) Assignee: CYBER360, INC., OVERLAND PARK, KS (US)

(21) Appl. No.: 13/296,031

(22) Filed: Nov. 14, 2011

(51) Int. Cl. G06F 17/27

(52) U.S. Cl. 704/9; 704/E11.001

(57) ABSTRACT

An online monitoring system assists parents or other individuals in monitoring social networking activity and/or mobile phone usage of their children or others. The online monitoring system may gather data corresponding with monitored social networking and/or mobile phone accounts. The data may be analyzed to provide summarized information and alert notifications to parents or other individuals. The analyses provided by the online monitoring service may include several text-based analyses: keyword analysis, sentiment analysis, and structure analysis. The keyword analysis may include analyzing text to determine whether it includes any blacklisted or whitelisted words. The sentiment analysis may include determining an overall sentiment of text based on the sentiment of words within the text. The structure analysis may include analyzing the sentence structure of the text to identify grammatical parts. An overall structure score is determined based on the sentiment of the grammatical parts.

### BACKGROUND

The widespread adoption and increasing use of technology by children, including Internet usage, social networking and mobile phones in particular, has in many ways made parenting an even more challenging task. In addition to traditional issues with raising children, parents now need to be concerned with protecting their children from online threats, such as cyber-bullying and online sexual predators. Additionally, parents often attempt to monitor their children's online social networking activities for inappropriate behavior and poor choices (e.g., drug usage, underage drinking, sexual activity, etc.). Parents may also wish to prevent their children from posting inappropriate content that may tarnish their children's “online reputation” and may come to haunt them later in life.

Many parents' approach to this problem is to “friend” their children on social networking sites or to require their children to provide the credentials to their social networking accounts so the parents can log into and monitor their children's accounts. However, given the incredible amount of social networking activity by some youth and the growing number of social networking sites, this approach is often unfeasible given the amount of time it would require parents to properly monitor their children.

Some automated solutions have been introduced to assist parents. For instance, a number of solutions are available that may be installed on a computer to help parents protect their children. These solutions may, for instance, track keystrokes entered on the computer, track webpages visited, block certain activity (e.g., visiting certain webpages), take screenshots at certain time intervals, and/or perform additional functions. However, these solutions are limited to the computer(s) on which they are installed and often provide a large amount of information that is still time-consuming for parents to review. Other network-based solutions have also been introduced that may not be limited to a particular computer. However, these solutions still fall short in providing parents with the tools to both effectively and efficiently monitor their children.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an online monitoring system for monitoring social networking and/or mobile phone accounts. A parent or other individual may register with the online monitoring system to have children's or other individuals' accounts monitored. The online monitoring system may collect data associated with monitored accounts and analyze the data to provide summarized information and alert notifications. Among other things, the online monitoring system may provide a number of text-based analyses, including a keyword analysis, a sentiment analysis, and a structure analysis. The keyword analysis may analyze text to determine whether it contains any blacklisted and/or whitelisted words. The sentiment analysis may analyze an overall sentiment of the text based on a sentiment for words within the text. The structure analysis may analyze the sentence structure of the text to identify grammatical parts, and a structure score may be calculated based on a sentiment for the grammatical parts.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the invention may be employed;

FIG. 3 is a flow diagram showing a method for analyzing text to provide alert notifications in accordance with an embodiment of the present invention;

FIG. 4 is a flow diagram showing a method for performing a keyword analysis of text in accordance with an embodiment of the present invention;

FIG. 5 is a flow diagram showing a method for performing a sentiment analysis of text in accordance with an embodiment of the present invention; and

FIG. 6 is a flow diagram showing a method for performing a structure analysis of text in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As indicated above, embodiments of the present invention are generally directed to an online monitoring system that monitors social networking activity and/or mobile phone usage of children or others. The online monitoring system may be configured to monitor a wide variety of different social networking sites and mobile phone services. A parent or other individual may create a monitoring account with the online monitoring system to monitor any number of automatically or manually identified social networking accounts and mobile phone accounts. Additionally, a parent or other individual may provide credentials for the monitored accounts to allow the online monitoring system to access non-public information from the accounts.

The online monitoring system may access data from monitored accounts and additional sources identified as having some correspondence with a monitored account. The online monitoring system may process the data to provide summary information and alert notifications that may be presented to the parent or other individual monitoring the activity of a child or other person. In accordance with embodiments of the invention, the data may be processed by performing analysis of text. The text-based analysis may include keyword analysis, sentiment analysis, and structure analysis. The keyword analysis includes analyzing the text to identify blacklisted or whitelisted words. The sentiment analysis includes analyzing an overall sentiment of the text based on sentiment scores for words of the text. The structure analysis includes analyzing the sentence structure of the text to identify grammatical parts, and a structure score for the text is determined based on a sentiment scores for the grammatical parts.

Accordingly, in one aspect, an embodiment of the present invention is directed to one or more computer-storage media-storing computer useable instructions that, when used by one or more computing devices, cause the one or more computing devices to perform a method. The method includes receiving text corresponding with a social networking account being monitored. The method also includes performing a keyword analysis of the text in which the text is analyzed to determine if the text includes any blacklisted words, performing a sentiment analysis of the text in which a sentiment of the text is analyzed based on sentiment scores for words of the text, and performing a structure analysis of the text in which a sentence structure of the text is analyzed to identify grammatical parts and a structure score for the text is determined based on a sentiment score for at least a portion of the grammatical parts. The method further includes generating an electronic alert notification for the text based on at least one of the keyword analysis, sentiment analysis, and structure analysis of the text. The method still further includes providing the electronic alert notification for presentation to a user.

In another embodiment, an aspect of the invention is directed to one or more computer-storage media-storing computer useable instructions that, when used by one or more computing devices, cause the one or more computing devices to perform a method. The method includes receiving text corresponding with a social networking account being monitored and parsing the text to identify a plurality of words in the text. The method also includes accessing a sentiment data store storing sentiment scores for a dictionary of words and identifying a sentiment score, from the sentiment data store, for each word from the plurality of words identified in the text. The method further includes calculating a sentiment score for the text based on the sentiment score for each word from the plurality of words from the text. The method also includes determining that the sentiment score satisfies a threshold. The method still further includes providing an electronic alert notification for presentation to a user in response to determining that the sentiment score satisfies the threshold.

A further embodiment of the present invention is directed to one or more computer-storage media storing computer useable instructions that, when used by one or more computing devices, cause the one or more computing devices to perform a method. The method includes receiving text corresponding with a social networking account being monitored and analyzing a sentence structure of the text to identifying a plurality of grammatical parts. The method also includes, for each grammatical part: identifying one or more words within the grammatical part, accessing a sentiment data store storing sentiment scores for a dictionary of words, identifying a sentiment score, from the sentiment data store, for each of the one or more words within the grammatical part, and calculating a sentiment score for the grammatical part based on the sentiment score for each of the one or more words within the grammatical part. The method further includes calculating a structure score for the text based on the sentiment score for each grammatical part from the plurality of grammatical part and determining that the structure score satisfies a threshold. The method still further includes providing an electronic alert notification for presentation to a user in response to determining that the sentiment score satisfies the threshold.

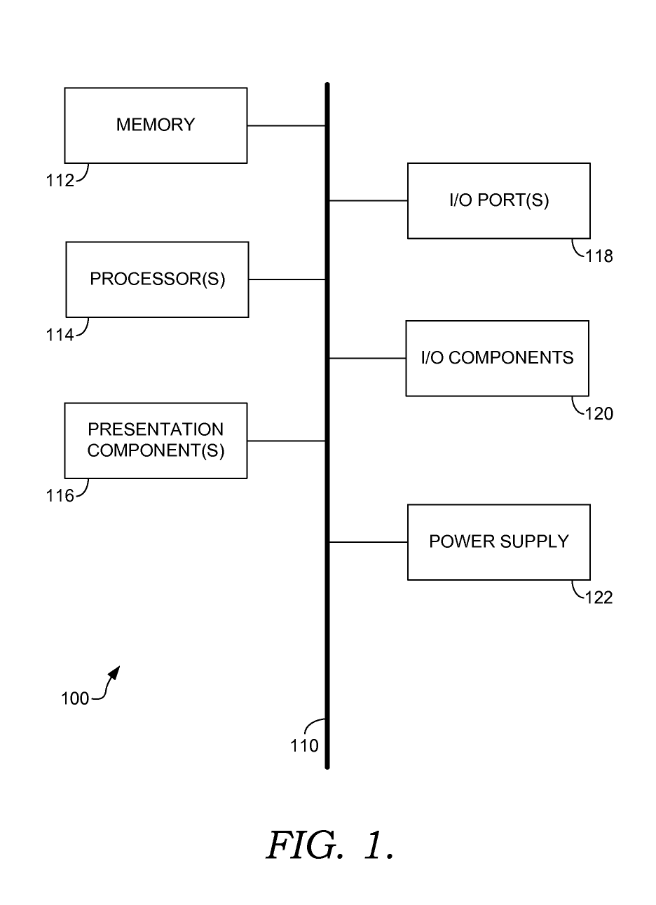

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously noted, embodiments of the present invention may be implemented as part of an online monitoring system that may be used to monitor social networking and mobile phone activity of individuals. Initially, a parent or other individual may create an account with the online monitoring system to monitor any number of children or other individuals. In addition to creating a monitoring system account, any number of social networking accounts and/or mobile phone accounts may be identified for monitoring. To do this, the parent or other individual may enter the email address of a child or other individual to be monitored. Using the email address, the online monitoring system may identify public information that indicates social networking accounts and/or mobile phone accounts tied to that email address. The parent or other individual may then select accounts to monitor. Additionally, the parent or other individual may manually identify other accounts to monitor. To the extent the parent or other individual has credential information, they may also provide the online monitoring system the credentials for accounts to allow the monitoring system to access non-public information for those accounts.

As used herein, the term “monitoring person” refers to the parent or other individual who wishes to monitor the social networking and/or mobile phone activity of another person. The term “monitored person” refers to the child or other individual whose social networking and/or mobile phone activities are monitored by the online monitoring system. Additionally, the term “monitored account” refers to a social networking account or a mobile phone account that is monitored by the online monitoring system. Although embodiments may be described herein in which a parent is the monitoring person who monitors a child's social networking and/or mobile phone usage, it should be understood that the online monitoring system may be employed by other entities to monitor individuals. For instance, the online monitoring system could be used by employers to monitor their employees.

After a monitoring system account is established and social networking and/or mobile phone accounts have been identified, the online monitoring system begins monitoring those accounts. The online monitoring system may be configured to monitor any number of different social networking sites, such as accounts from the FACEBOOK, TWITTER, MYSPACE, GOOGLE+, BEBO, and FRIENDSTER social networking sites, to name a few. The online monitoring system may access data from monitored accounts on the social networking sites and may analyze the data for any number of different issues.

The social networking monitoring performed by the online monitoring system may include, among other things: detecting registration to social networks, detecting password changes, keyword and context based matching, analyzing privacy settings, displaying photos/videos posted by the monitored person, displaying photos/videos in which the monitored person is tagged, analyzing the monitored person's comments on posts by others, analyzing the monitored person's posts/status messages, analyzing posts that tag the monitored person, background check on all friends of the monitored person, criminal records check on all friends of the monitored person, age check on all friends of the monitored person, number of friends in common with the monitored person's other friends, quantity of time on different social networks, analyzing URL links posted or bookmarked by the monitored person, analyzing groups to which the monitored person belongs, analyzing pages the monitored person has “liked,” analyzing the monitored person's profile (e.g., interests, education, job, relationships, about me, sex, etc.), analyzing the monitored person's events, analyzing the monitored person's “check-ins” or tagged “check-ins,” detecting when the monitored person shares passwords with friends, detecting when the monitored person is friends with someone outside their local area, monitoring chat for keywords and context, verifying birthdate with posted birthdate, and verifying posted name is the monitored person's name.

The online monitoring system may also collect data of monitored mobile phone accounts. The data may be collected from a mobile service provider and/or directly from a mobile phone. The mobile phone monitoring may include, among other things: phone usage (e.g,. day/time of call, called/calling number or person, duration, etc.), GPS/location tracking, text message usage (e.g., day/time of text, texted/texting number or person, etc.), and text message context analysis.

As will be described in further detail below, embodiments of the present invention provide text-based analysis of text retrieved by the online monitoring system. The text-based analysis may include keyword analysis, sentiment analysis, and structure analysis. The keyword analysis includes analyzing the text to identify blacklisted or whitelisted words. The sentiment analysis includes analyzing an overall sentiment of the text based on sentiment scores for words of the text. The structure analysis includes analyzing the sentence structure of the text to identify grammatical parts and a structure score for the text is determined based on a sentiment scores for the grammatical parts.

The online monitoring system may provide a user interface to allow a monitoring person to view a summary of information associated with monitored social networking and mobile phone accounts. For instance, a web-based dashboard may be provided by the online monitoring system to the monitoring person. The user interface may provide a variety of different information accessed for monitored accounts, and the monitoring person may customize the information included. This may include, for instance, information regarding social monitoring activities and usage and mobile phone usage. A variety of alert notifications may also be provided based on analysis of information associated with the social networking and mobile phone accounts. The user interface may also provide a photo/video section that may include photos/videos posted by the monitored person, others' photos/videos in which the monitored person is tagged, and photos/videos from the monitored person's mobile phone. Location information may also be provided based on GPS or other location information from mobile phones, as well as location information that may be derived from other sources, such as social networking “check-ins.” A monitoring person may also provide a schedule of locations indicating where a monitored person is expected to be at different times, and the online monitoring system may provide alert notifications if it determines that the monitored person's location differs from the scheduled location at a particular time. The user interface may also provide access to resources that provide advice from experts or other parents.

In addition to providing a user interface that a monitoring person may access to view information and alert notifications, the online monitoring system may delivery real-time alerts to monitoring persons. These alerts may be provided via any of a variety of different electronic communications, such as email, text messages, and push notifications on mobile devices.

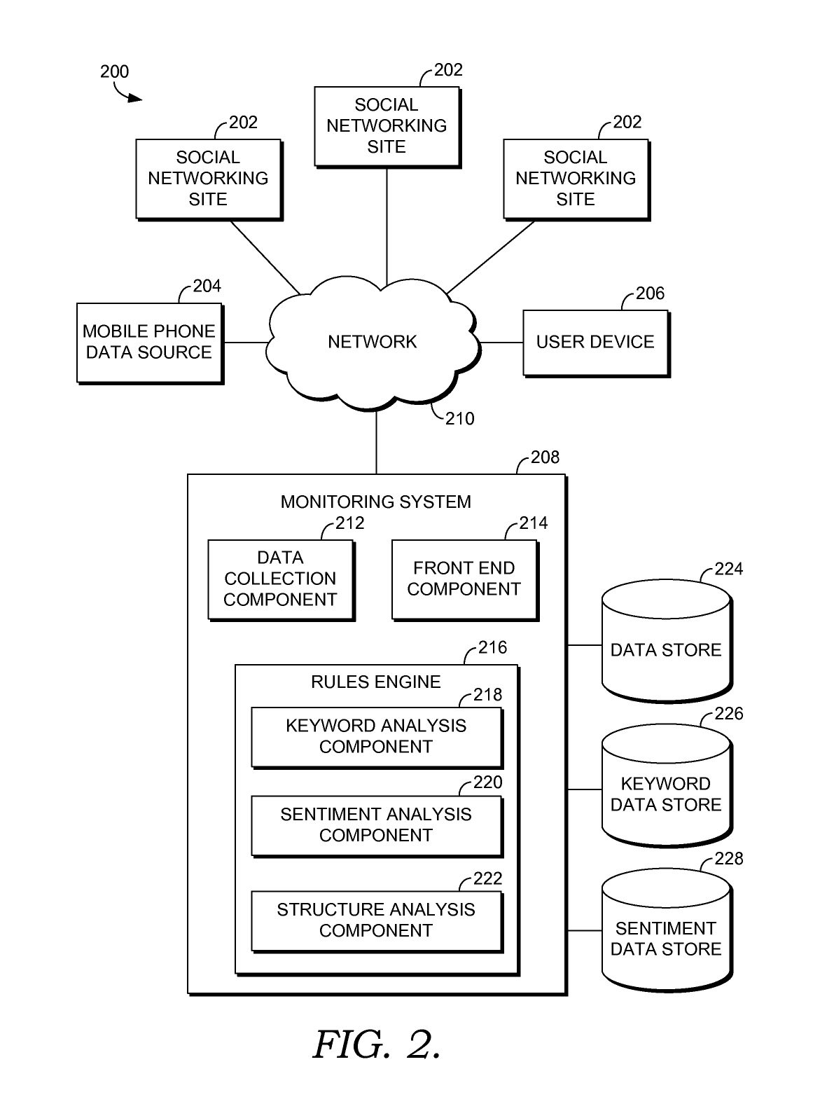

Referring next to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 may include social networking sites 202, mobile phone data source 204, user device 206, and monitoring system 208. Each of the components shown in FIG. 2 may be any type of computing device, such as computing device 100 described with reference to FIG. 1, for example. The components may communicate with each other via a network 210, which may include, without limitation, one or more local area networks (LANs) and/or wide area networks (WANs). Such networking environments are commonplace in offices, enterprise-wide computer networks, intranets, and the Internet. It should be understood that any number of social networking sites, mobile phone data sources, user devices, and monitoring systems may be employed within the system 200 within the scope of the present invention. Each may comprise a single device or multiple devices cooperating in a distributed environment. For instance, the monitoring system 208 may comprise multiple devices arranged in a distributed environment that collectively provide the functionality of the monitoring system described herein. Additionally, other components not shown may also be included within the system 200.

In the embodiment shown in FIG. 2, the monitoring system 208 includes, among other things, a data collection component 212, a front end component 214, and a rules engine 216. The monitoring system 208 generally operates to access data associated with monitored social networking and mobile phone account at the social network sites 202 and mobile phone data source 204, analyze the data, and provide summarized information and analysis results for presentation to a monitoring person.

Initially, a monitoring person, such as a parent of a minor, may employ a user device 206 to access the front end component 214 of the monitoring system 208 to create an account with the monitoring service. As part of creating the account, any number of social networking accounts may be identified for monitoring. Additionally, in some embodiments, one or more mobile phones and/or mobile phone accounts may be identified for monitoring. Social networking accounts may be identified in a number of different manners. The front end component 214 may provide a user interface to the user device 206 that allows the monitoring person to enter information for identifying the social networking account. In some embodiments, the monitoring person may enter an email account (or multiple email accounts) for a person to be monitored. The monitoring system 208 may then search for social networking accounts attached to that email address and provide an indication to the monitoring person, who may then select to monitor those accounts. The monitoring person may also manually identify social networking accounts to monitor. Additionally, the monitoring person may provide credentials for automatically and/or manually identified social networking accounts to allow the system to access non-public information from the accounts. For example, in the case in which a parent is monitoring a child's account, the parent may request the account credentials from the child and enter the credentials into the monitoring system 208. A mobile phone account could be identified by providing information such as the phone number of the mobile phone, mobile phone service provider (e.g., mobile phone carrier) information, and/or credentials for the mobile phone account with the mobile phone service provider.

After an account is created with the monitoring service, the data collection component 212 operates to collect data corresponding with the identified social networking accounts and/or mobile phone accounts (i.e., the monitored accounts). In embodiments, the data collection component 212 may access information from monitored accounts at social networking sites 202. The data collection component 212 may access data from monitored accounts at the social networking sites 202 in any of a variety of different manners. For instance, in some embodiments, the data collection component 212 may use APIs provided by a social networking site 202 for the purpose of gathering data from accounts hosted by the site 202. In some embodiments, the data collection component 212 may operate by logging into a monitored account at a social networking site 202 and pulling data from the account. In some cases, the data may be publicly available information, and in other cases, the data may include non-public information from a monitored account if the proper credentials are provided. Any and all such variations are contemplated to be within the scope of embodiments of the present invention.

A variety of different types of data may be collected from monitored social networking accounts, including text, images, and videos. By way of example only and not limitation, the text collected may include posts, profile information, text used to tag photos/videos, and messages. The collected data may be data entered by the monitored person, including data the monitored person enters into the monitored social networking account and data the monitored person may enter into another person's social networking account via the monitored account (e.g., the monitored person writing on the “Wall” of another person's FACEBOOK account). The collected data may also include data entered by other people. For instance, data may be collected when another person writes on the “Wall” of the monitored account or sends a message to the monitored person via the monitored account.

Data may also be collected about a monitored person from another person's social networking account. For instance, another person may tag a monitored person in a photo on that other person's account. If the data collection component 212 has access to such data, the monitoring system may identify the data as corresponding with the monitored person even if the information is not from the monitored person's social networking account.

A variety of different data may also be collected from mobile phone data sources, such as the mobile phone data source 204. Generally, mobile phone data sources may include a mobile phone service provider and/or a mobile phone of the monitored person. The data may include phone records (including call information and text information—time, incoming/outgoing phone number, duration, etc.). The data may also include photos, videos, content of text messages, and location information. Access to much of this data may be dependent upon the monitoring system 208 being provided the proper credentials for the mobile phone account from the monitoring person. In some embodiments, an application may be installed on the monitored person's mobile phone to facilitate the data collection component 212 in collecting data from the mobile phone directly.

In addition to collecting data from social networking sites 202 and mobile phone data source 204, the data collection component 212 may access data from other sources if the data is identified as corresponding with the monitored person and/or a monitored account. By way of example to illustrate, a monitored person's social networking account may include data indicating that the monitored person “liked” a particular webpage. Based on this, the data collection component 212 may access data from that particular webpage, including text, images, and videos from the webpage. Generally, any data that has some connection to a monitored person via a monitored account may be accessed by the data collection component.

Data collected by the data collection component 212 may be stored in a data store 224 for the monitoring system 208. The data collection component 212 may be configured to recognize the various pieces of collected data and may store the data in a structured format in the data store 224 to facilitate further analysis of the data and presentation of information based on the data to the parent or other monitoring person.

The rules engine 216 is operable to analyze collected data in the data store 224 to identify issues. Generally, the rules engine 216 may include a variety of rules for analyzing the data. In addition to other types of analysis, the rules engine 216 performs three types of textual analysis for triggering alert notifications. As shown in FIG. 2, the rules engine 216 includes, among other components not shown, a keyword analysis component 218, a sentiment analysis component 220, and a structure analysis component 222.

The keyword analysis component 218 operates to identify blacklisted and/or whitelisted words in collected text to determine whether to provide alert notifications based on identification of such words. The blacklisted or whitelisted words may be maintained in a keyword data store 226. The included words may be predefined by the monitoring system 208. A parent or other monitoring person may edit the blacklisted words or whitelisted words by adding and/or removing words from the lists. Additionally, a different collection of blacklisted words or whitelisted words may be maintained in the keyword data store 226 for different monitored persons. For example, a parent may have two children the parent wishes to monitor. The children may be of different ages such that the parent feels that certain words are acceptable for one child while not for the other. As such, different blacklisted words or whitelisted words may be used for the two children to provide a keyword analysis customized to each child based on the parent's preferences.

The sentiment analysis component 220 goes beyond simple keyword analysis by analyzing the sentiment of words contained in text being analyzed. A sentiment data store 228 is employed to maintain a dictionary of words and a sentiment score for each word representing the sentiment of each word. The sentiment score for a word may comprise a value that indicates where the word falls in the range from benign to offensive (or otherwise troublesome). For instance, a sentiment score for a word may range from 0.0 (benign) on one end to 1.0 (offensive) on the other end. The sentiment scores for words may be predefined by the monitoring system 208 and/or may be user-defined. For instance, a slider may be provided on a user interface that allows a parent to adjust the sentiment score assigned to a given word. Additionally, a monitoring person may add words to and/or remove words from the sentiment data store 228. Although the keyword data store 226 and sentiment score data store 228 are shown as separate components in FIG. 2, in some embodiments, a single data store may be employed to provide blacklisted/whitelisted words for the keyword analysis and sentiment scores for the sentiment analysis.

To generate a sentiment score for a text portion (e.g., a sentence or other collection of words), the sentiment analysis component 220 parses the text to identify words in the text and looks up the sentiment scores for respective words from the sentiment data store 228. A sentiment score for the text is then calculated based on the sentiments scores of the words. In some embodiments, this may include calculating an average of the sentiment scores for the words.

The structure analysis component 222 takes into account the structure of sentences. In particular, the structure analysis component 222 analyzes the sentence structure of text being analyzed to identify different grammatical parts. In some embodiments, the different parts may be identified as nouns, verbs, adjectives, adverbs, pronouns, prepositions, and conjunctions. In some embodiments, the identified parts may be subject, verb, and object.

A sentiment score for grammatical parts is determined based on the sentiment score of each word in each grammatical part. In some embodiments, all grammatical parts are used in computing the structure score for the text, while in other embodiments, only certain grammatical parts are employed. For instance, in some embodiments, only grammatical parts considered to be important are used to calculate the structure score while other grammatical parts are ignored. This may include the subject, verb, and, if present, the object or subjective complement in embodiments. In some embodiments, weighting may be applied to different grammatical parts based on the type of each grammatical part. This may include applying a higher weighting to grammatical parts considered to be more important.

It should be noted that that use of “word” herein is intended to cover single words as well as multi-word phrases. As such, the keyword data store 226 and sentiment score data store 228 may include both single words and multi-word phrases as individual entries. Additionally, the data stores 226 and 228 may include variations of words and misspellings to assist identification of words in text. For instance, a child may use “s3x” instead of “sex” as an attempt to bypass the text analyses. By including the variations/misspellings of words, the monitoring system 208 can more effectively analyze the text.

Any number of alert notifications may be triggered based on the keyword, sentiment, and structure analyses. In some embodiments, the keyword analysis component 218 may trigger an alert notification simply if a blacklisted word is identified. In some embodiments, the keyword analysis component 218 may employ both a blacklist and whitelist to determine whether to trigger an alert notification. Generally, the whitelist may overrule the blacklist, although the importance or weighting of each list may be configurable. For instance, if a word is found in text that is both on the blacklist and the whitelist, the system may determine whether to provide an alert notification. In some embodiments, the system may provide different tiers of whitelists and blacklists that may be employed by the system to determine whether to provide an alert notification.

The sentiment analysis component 220 may trigger an alert notification if the sentiment score for text is greater than some threshold, which may be predefined by the system 208 and/or set by the monitoring person. The structure analysis component 222 may trigger an alert notification if the structure score for text is greater than some threshold, which also may be predefined by the system 208 and/or set by the monitoring person. In some embodiments, the same threshold may be used for both the sentiment analysis and the structure analysis, while in other embodiments different thresholds may be employed for the different analyses. In some embodiments, the alert notifications may be classified based on the content that triggered them.

By way of example, the alert notifications may be classified as inappropriate language, sexual, alcohol, drugs, or any of a variety of other types of classifications.

The front end component 214 is configured to aggregate and present information to the monitoring person in a useful manner. A web-based dashboard or other user interface may by provided by the front end component 214 to the user device 206 to allow the monitoring person to review the information and alert notifications. Additionally, the front end component 214 may provide real-time alert notifications to a monitoring person via emails, text messages, push notifications, or other forms of electronic communication.

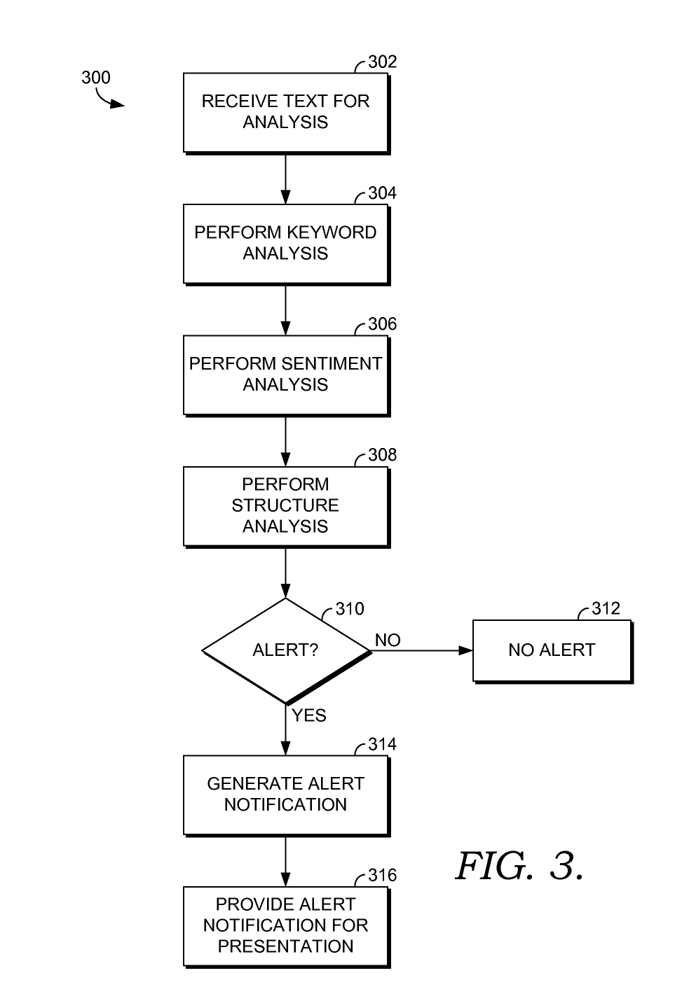

With reference now to FIG. 3, a flow diagram is provided that illustrates a method 300 for analyzing text to provide alert notifications in accordance with an embodiment of the present invention. The embodiment discussed with reference to FIG. 3 monitors text and determines whether an alert should be provided using three types of analysis: keyword analysis, sentiment analysis, and structure analysis. As shown at block 302, text is received for analysis. Generally, the text being analyzed corresponds with a social network account being monitored but may be acquired from a variety of different sources. By way of example only and not limitation, the text may come from social networking posts, profiles, text tagging photos/videos, and text messages, to name a few. In some cases, the text may have been entered by the monitored person. In other cases, the text may have entered by another person. The text may originate from the monitored person's social networking account, another person's social networking account, the monitored person's mobile phone account, or some other source as long as the text is identified as having some relationship to the monitored person.

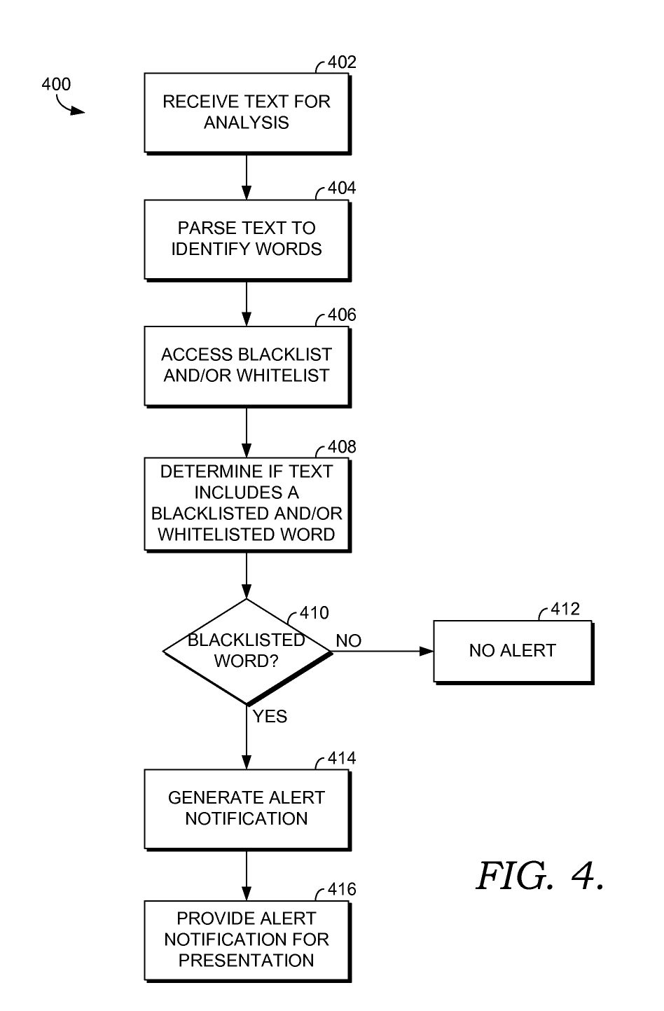

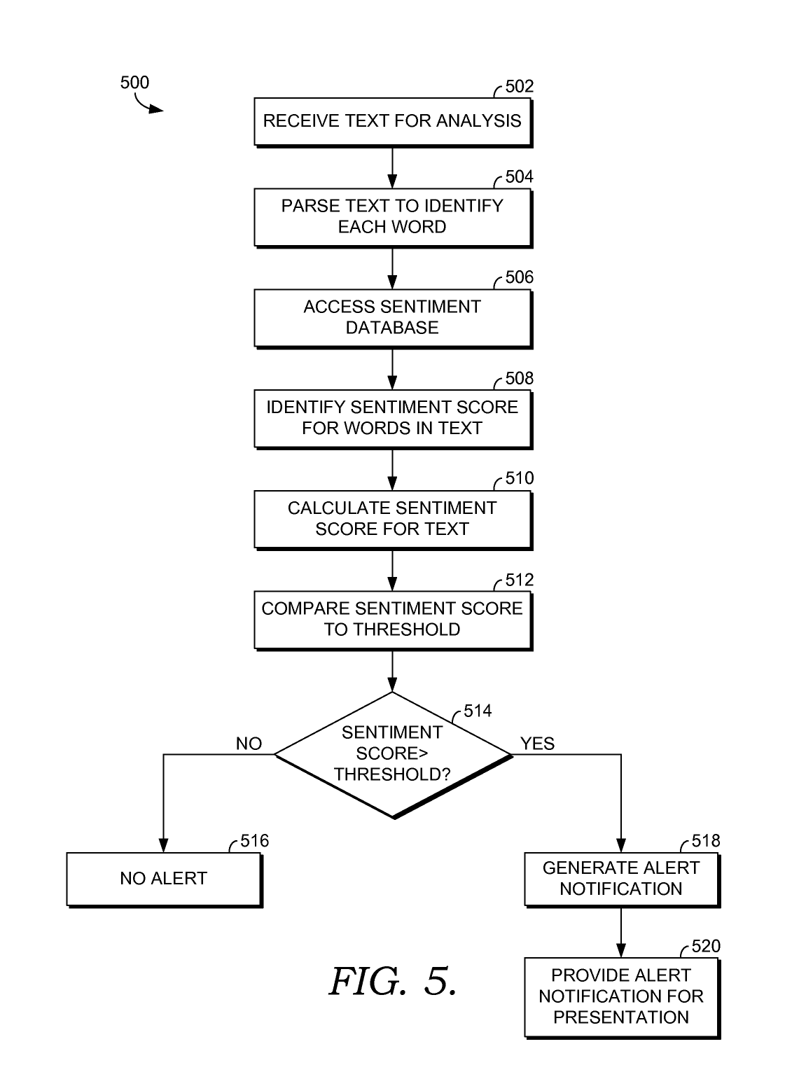

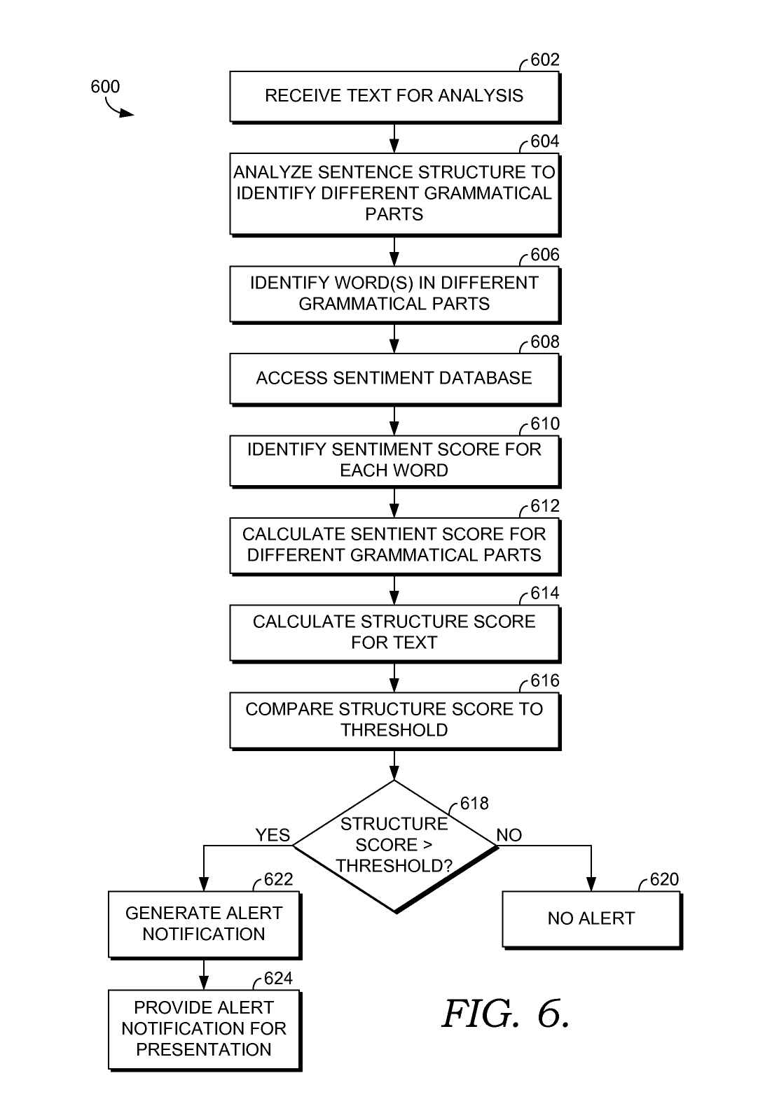

As shown at block 304, a keyword analysis of the text is performed. As will be described in further detail below with reference to FIG. 4, the keyword analysis may include parsing the text to identify the individual words of the text and determining if any of the words are contained in a blacklist or whitelist maintained by the system. A sentiment analysis is also performed, as shown at block 306. As will be described in further detail below with reference to FIG. 5, the sentiment analysis may include parsing the text to identify the individual words and determining a sentiment score for the words based on a sentiment score database maintained by the system. A sentiment score for the text is then determined based on the sentiment scores of the words contained in the text. Finally, a structure analysis is performed, as shown at block 308. As will be described in further detail below with reference to FIG. 6, the structure analysis includes analyzing the text to identify grammatical parts of the sentence and determining a sentiment score for the grammatical parts. A structure score for the text is then determined based on the sentiment scores of the grammatical parts.

As shown at block 310, a determination is made regarding whether to provide an alert notification based on the keyword analysis, sentiment analysis, and/or the structure analysis. Any number of alert notifications may be provided based on analysis of a given text portion. In some embodiments, each analysis may be considered separately to determine whether an alert notification should be provided as an outcome of each analysis. For instance, the keyword analysis component may trigger an alert notification if a blacklisted word is identified that is not cleared by a whitelist, the sentiment analysis may trigger an alert notification if the sentiment score for the text satisfies a threshold, and the structure analysis may trigger an alert notification if the structure score for the text satisfies a threshold. In some embodiments, the different analyses may all be taken into consideration when determining what alert notifications to provide. For instance, if both the structure analysis and sentiment analysis trigger an alert notification for similar reasons, only one alert notification may be provided.

If it is determined at block 310 that an alert notification is not needed for the text based on the keyword analysis, sentiment analysis, and/or the structure analysis, no alert notification is provided, as shown at block 312. Alternatively, if it is determined at block 310 that an alert notification is needed, an alert notification is generated, as shown at block 314. In some instances, multiple different types of alerts may be triggered by the keyword analysis, sentiment analysis, and/or structure analysis for the same text. In such instances, multiple alert notifications may be generated at block 316. The alert notification (or multiple alert notifications) is then provided for presentation to an end user. An alert notification may be provided to the end user in any of a number of different ways. For instance, an alert notification may be provided on a dashboard or other user interface provided by the monitoring system (e.g., via a webpage interface) to provide monitoring information to the end user. As other examples, an alert notifications may be provided to the end user in real-time via a text message, an email, a push notification on a mobile phone via an installed application, or other electronic communication approaches.

FIG. 4 provides a flow diagram illustrating a method 400 for performing a keyword analysis of text in accordance with an embodiment of the present invention. Initially, text is received for analysis, as shown at block 402. The text is parsed at block 404 to identify words within the text. A blacklist and/or whitelist at a keyword data store is accessed at block 406. In some embodiments, only a blacklist may be employ to trigger alert notifications, while in other embodiments, a whitelist may also be used. The blacklist includes a list of blacklisted words that, if found within text being analyzed, will trigger an alert notification. The whitelist includes words that may be ignored from analysis and/or may weigh against triggering an alert notification based on a blacklisted word. As noted above, the words in the blacklist or whitelist may be system-defined and/or user-defined.

A determination is made at block 408 regarding whether the text includes any blacklisted and/or whitelisted words. If it is determined at block 410 that the text does not include any blacklisted words, no alert notification is provided, as shown at block 412. Alternatively, if it is determined at block 410 that the text includes one or more blacklisted words, an alert notification may be generated, as shown at block 414. The alert notification is then provided for presentation to a user, as shown at block 416. If the text contained any whitelisted words, they may automatically be ignored from analysis.

Turning to FIG. 5, a flow diagram is provided that illustrates a method 500 for performing a sentiment analysis of text in accordance with an embodiment of the present invention. As shown at block 502, text that is to be analyzed is received. The text is parsed to identify each word in the text, as shown at block 504. A sentiment database that contains sentiment scores for words is accessed, as shown at block 506. As noted previously, the sentiment scores for words in the sentiment database may be system-assigned scores and/or may be user-assigned scores. Sentiment scores for words from the text are identified from the sentiment database, as shown at block 508. In various embodiments, this may include identifying a sentiment score for all or only a portion of the words in the text.

A sentiment score for the text is calculated from the sentiment scores of the words from the text, as shown at block 510. In some embodiments, the sentiment score for the text may comprise an average of the sentiment scores for the words. For instance, the sentiment score may be calculated by summing the sentiment scores of the words and dividing that sum by the number of words.

The sentiment score for the text is compared against a threshold, as shown at block 512. As discussed previously, the threshold may be system-defined and/or user-defined. A determination is made at block 514 regarding whether the sentiment score for the text satisfies the threshold (e.g., by exceeding the threshold). If the sentiment score does not satisfy the threshold, no alert notification is provided, as shown at block 516. Alternatively, if it is determined at block 514 that the sentiment score satisfies the threshold, an alert notification is generated, as shown at block 518. The alert notification is then provided for presentation to a user, as shown at block 520.

Referring next to FIG. 6, a flow diagram is provided that illustrates a method 600 for performing a sentiment analysis of text in accordance with an embodiment of the present invention. As shown at block 602, text to be analyzed is initially received. The sentence structure of the text is analyzed at block 604 to identify different grammatical parts. In some embodiments, this may include breaking a sentence into chunks of words. The system may then start at the left and work to the right looking for certain grammatical phrases in order and inferring others based on the presence or absence of other phrases. For example, if a noun phrase is found just before a verb phrase, the noun phrase is presumed to be the subject. If a noun phrase is not found before the verb phrase, the subject is assumed to be an ‘understood’ subject, such as “you” in command sentences.

In some embodiments, identifying different grammatical parts may include identifying different parts of the text as nouns, verbs, adjectives, adverbs, pronouns, prepositions, and conjunctions. In some embodiments, identifying different grammatical parts may include identifying different parts of the text as a subject, verb, and object. Each grammatical part may include a single word or a combination of words from the text.

In some embodiments, all grammatical parts from the text may be further analyzed, while in other embodiments, only grammatical parts considered to be important are further processed. For the grammatical parts being further analyzed, the process continues by identifying the word or words within each of the grammatical parts, as shown at block 606. A sentiment database that contains sentiment scores for words is accessed, as shown at block 608. A sentiment score of each of the words from the grammatical parts is identified from the sentiment database, as shown at block 610. Based on the words in each grammatical part and the sentiment score for each of those words, a sentiment score for each grammatical part is calculated, as shown at block 612.

A structure score for the text is then calculated, as shown at block 614, based on the sentiment scores for the grammatical parts of the text. In some embodiments, the structure score for the text may be an average of the sentiment scores for the grammatical parts of the text. For instance, the structure score may be calculated by summing the sentiment scores of the grammatical parts and dividing that sum by the number of grammatical parts. In some embodiments, weighting may be applied to the various grammatical parts. In particular, different grammatical parts may be weighted differently, for instance, based on the importance of the various grammatical parts.

The structure score for the text is compared against a threshold, as shown at block 616. As discussed previously, the threshold may be system-defined and/or user-defined. A determination is made at block 618 regarding whether the structure score for the text satisfies the threshold (e.g., by exceeding the threshold). If the structure score does not satisfy the threshold, no alert notification is provided, as shown at block 620. Alternatively, if it is determined at block 618 that the structure score satisfies the threshold, an alert notification is generated, as shown at block 622. The alert notification is then provided for presentation to a user, as shown at block 624.

In some embodiments, the blacklist and/or whitelist discussed with reference to FIG. 4 may play into the sentiment and structure calculations of FIGS. 5 and 6 as the presence of a word on a blacklist or whitelist may exclude or include the phrase in the sentiment and structure calculations.

As can be understood, embodiments of the present invention provide an online monitoring system configured to provide robust text analysis to monitor social networking site activity and/or mobile phone usage of children and other individuals.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-storage media-storing computer useable instructions that, when used by one or more computing devices, cause the one or more computing devices to perform a method, the method comprising:
receiving text corresponding with a social networking account being monitored;
performing a keyword analysis of the text in which the text is analyzed to determine if the text includes any blacklisted words;
performing a sentiment analysis of the text in which a sentiment of the text is analyzed based on sentiment scores for words of the text;
performing a structure analysis of the text in which a sentence structure of the text is analyzed to identify grammatical parts and a structure score for the text is determined based on a sentiment score for at least a portion of the grammatical parts;
generating an electronic alert notification for the text based on at least one of the keyword analysis, sentiment analysis, and structure analysis of the text; and
providing the electronic alert notification for presentation to a user.

2. The one or more computer storage media of claim 1, wherein the social networking account being monitored comprises a social networking account of a minor being monitored by a parent or guardian of the minor.

3. The one or more computer storage media of claim 1, wherein receiving the text comprises accessing the text from a data store storing data obtained for the social networking account being monitored, the data store storing the data in a structured format that facilitates analysis of the data.

4. The one or more computer storage media of claim 1, wherein the text corresponding with the social networking account being monitored comprises text entered via the social networking account being monitored by an account holder of the social networking account.

5. The one or more computer storage media of claim 1, wherein the text corresponding with the social networking account being monitored comprises text from another source viewed by an account holder of the social networking account.

6. The one or more computer storage media of claim 1, wherein performing a sentiment analysis of the text comprises:
parsing the text to identify each word in the text;
identifying a sentiment score for each of at least a portion of the words in the text; and
determining an overall sentiment score for the text based on the sentiment scores for the at least a portion of the words in the text.

7. The one or more computer storage media of claim 6, wherein the sentiment score for at least one word is defined by the user.

8. The one or more computer storage media of claim 1, wherein performing a structure analysis of the text comprises:
analyzing the text to identify one or more grammatical parts of the text;
for each grammatical part:
identifying one or more words in the grammatical part,
identifying a sentiment score for at least a portion of the one or more words in the grammatical part, and
determining a sentiment score for the grammatical part based on the sentiment scores for the at least a portion of the one or more words in the grammatical part; and
determining a structure score for the text based on the sentiment scores for the one or more grammatical parts.

9. The one or more computer storage media of claim 8, wherein the one or more grammatical parts comprise all grammatical parts of the text.

10. The one or more computer storage media of claim 8, wherein the one or more grammatical parts comprise only grammatical parts of the text deemed to be important relative to other grammatical parts of the text.

11. The one or more computer storage media of claim 8, wherein determining the structure score for the text includes applying weighting to sentiment scores of different grammatical parts.

12. The one or more computer storage media of claim 1, wherein the electronic alert notification is provided via at least one selected from the following: a web-based dashboard, an email, a text message, and a push notification.

13. One or more computer-storage media-storing computer useable instructions that, when used by one or more computing devices, cause the one or more computing devices to perform a method, the method comprising:
receiving text corresponding with a social networking account being monitored;
parsing the text to identify a plurality of words in the text;
accessing a sentiment data store storing sentiment scores for a dictionary of words;
identifying a sentiment score, from the sentiment data store, for each word from the plurality of words identified in the text;
calculating a sentiment score for the text based on the sentiment score for each word from the plurality of words from the text;
determining that the sentiment score satisfies a threshold; and
providing an electronic alert notification for presentation to a user in response to determining that the sentiment score satisfies the threshold.

14. The one or more computer storage media of claim 13, wherein the sentiment score for at least one word from the plurality of words was defined by the user.

15. The one or more computer storage media of claim 13, wherein the sentiment score for the text is calculated by averaging the sentiment scores for the plurality of words from the text.

16. One or more computer-storage media storing computer useable instructions that, when used by one or more computing devices, cause the one or more computing devices to perform a method, the method comprising:
receiving text corresponding with a social networking account being monitored;
analyzing a sentence structure of the text to identifying a plurality of grammatical parts;
for each grammatical part:
identifying one or more words within the grammatical part,
accessing a sentiment data store storing sentiment scores for a dictionary of words,
identifying a sentiment score, from the sentiment data store, for each of the one or more words within the grammatical part, and
calculating a sentiment score for the grammatical part based on the sentiment score for each of the one or more words within the grammatical part;
calculating a structure score for the text based on the sentiment score for each grammatical part from the plurality of grammatical parts;
determining that the structure score satisfies a threshold; and
providing an electronic alert notification for presentation to a user in response to determining that the sentiment score satisfies the threshold.

17. The one or more computer storage media of claim 16, wherein the plurality of grammatical parts comprises all grammatical parts of the text.

18. The one or more computer storage media of claim 16, wherein the plurality of grammatical parts comprises only grammatical parts of the text deemed to be important relative to other grammatical parts of the text.

19. The one or more computer storage media of claim 16, wherein determining the structure score comprises averaging the sentiments scores of the plurality of grammatical parts.

20. The one or more computer storage media of claim 16, wherein determining the structure score for the text includes applying weighting to sentiment scores of different grammatical parts.
